(19) United States
(12) Patent Application Publication
(10) Pub. No.: US 2023/0009890 A1
(43) Pub. Date: Jan. 12, 2023

(54) ELECTRICAL CIRCUIT FOR INCREASING COMPATIBILITY BETWEEN LED DRIVERS AND DIMMER SWITCHES

(71) Applicant: STAR MICROELECTRONIC SYSTEMS, LLC, Saint Peters, MO (US)

(72) Inventor: David John Fowler, Saint Peters, MO (US)

(73) Assignee: STAR MICROELECTRONIC SYSTEMS, LLC, Saint Peters, MO (US)

(21) Appl. No.: 17/305,636

(22) Filed: Jul. 12, 2021

(51) Int. Cl. H05B 45/3577; H05B 45/345

(52) U.S. Cl. CPC H05B 45/3577; H05B 45/345

(57) ABSTRACT

An electrical circuit for providing led light bulb drivers with the necessary electrical load for most triac and digital dimmer switches and provide dimming control to mimic incandescent light bulbs is described herein. The electrical circuit includes a non-linear electrical load circuit that is electrically coupled to a rectified alternating current (AC) input power source and providing the necessary load current to initiate and maintain activation of triac and digital dimmer switches. A phase sense and amplifier circuit is also coupled to the rectified AC input power source and it senses the AC input voltage phase, then transmits a control signal to the light emitting diode (LED) driver to adjust the current level of the power being delivered to the LEDs in a manner to mimic the dimming of incandescent light bulbs.

### BACKGROUND OF THE INVENTION

The lighting industry transition to LEDs has yielded mixed results for backwards compatibility with the common triac based dimmer switches. Furthermore, LED light bulbs dim at different rates than from each other and from the incandescent light bulb. The consumer adoption of LED lighting has been hampered by the low compatibility to the triac dimmer and the favorable dimming experience of an incandescent. Despite government intervention to sway the public towards LED lighting, incandescent light bulbs continue to sell as they are a better fit for some homeowners who prefer linear dimming.

One of the problems to using a triac dimmer for LED lighting is the triac requires a charge current when the triac is off and requires a minimum load current when the triac is conducting as can be inferred from the charging circuit shown in the dimmer switch model in FIG. 1. The triac dimmers require a charging current to operate the time delay threshold of the diac, typically at 32V. Typical triac dimmers utilize a variable resistor and a 0.1 uF capacitor charging circuit. Because the load resistance is in series with the charge resistor, any resistive load above 5 kohm would assuredly influence the timing of the conduction. Any LED light bulb that presents a large input impedance when the triac is off, the triac charge current will take longer to charge up and initiate the next conducting phase, resulting in flickering or non-linear dimming effects. During the conduction phase of a triac dimmer, the minimum load current for a triac to maintain conduction is usually 30-50 mA. Any LED light bulb that draws current for only a portion of the conducting phase will result in the triac ending conducting early, resulting flickering or non-linear dimming effects.

Another problem with LED light bulbs is the inherent non-linear light output of LEDs relative to the LED current as shown in FIG. 2. At the low currents, the LED brightness changes dramatically. While at the rated LED current, the brightness changes are subtle. The LED driver within the LED light bulbs are most often designed to linearly scale the LED current to the AC input voltage conducting phase. But, as a result of the non-linear characteristics of the LED, the brightness increases faster than the incandescent counterpart. Leaving little control range to fine tune the lower brightness levels.

The present invention is aimed at one or more of the problems identified above to provide easier transition from the triac dimmer era of residential lighting and a better lighting experience for the consumer.

### SUMMARY OF THE INVENTION

In one aspect of the present invention, an electrical circuit for providing LED light bulb drivers the necessary electrical load for most triac and digital dimmer switches is provided, as shown in FIG. 4. The electrical circuit is non-linear and includes a current sense circuit, PNP transistor current amplifier, NPN transistor controller, N-channel MOSFET circuit, and NPN transistor load circuit. The current sense circuit is electrically coupled to a rectified AC input power source. The current sense circuit couples to the PNP transistor current amplifier, which couples to the NPN transistor controller, which couples to the N-channel MOSFET circuit, which couples back to the current sense circuit. The PNP transistor current amplifier also includes bias resistors. The NPN transistor controller also includes resistors and capacitors.

The N-channel MOSFET also includes bias resistors. The electrical circuit senses the input current and converts it to a control signal to adjust the N-channel MOSFET resistance in order to provide the minimum current necessary to maintain conduction. The NPN transistor load circuit is also non-linear and includes a N-channel MOSFET, bias resistors and a capacitor. The NPN transistor load circuit is couple to the dimmer circuit phase sense circuit and to the current sense circuit. The NPN transistor load circuit is enabled when the triac dimmer switch is not conducting and it provides a sufficient load to ensure the timing of the triac conduction is consistent with a incandescent light bulb load.

In another aspect of the present invention, an electrical circuit for providing the dimming control to mimic the incandescent light bulb is provided, as shown in FIG. 5. The electrical circuit includes a dimming phase sense circuit, a filter circuit, and a non-linear OPAMP circuit. The dimming phase sense circuit includes a Zener diode, voltage sense resistors, and a N-channel MOSFET. The Zener diode is coupled to a rectified AC input power source. The rectified AC voltage is sensed through the Zener diode to the sense resistors to enable a N-channel MOSFET. The N-channel MOSFET couples the dimming phase sense circuit to the filter circuit. The filter circuit includes a pull-up resistor, two low pass filters (resistor and capacitor), and a pull-up capacitor. The dimming phase sense circuit passes the phase signal through two low pass filters. The second low pass filter couples the filter circuit to the non-linear OPAMP circuit. The non-linear OPAMP circuit includes a bias resistor circuit, a feedback circuit, and a resistor voltage divider output. The feedback circuit within the OPAMP circuit includes resistors, diodes, and a Zener diode. The phase signal is amplified by the non-linear OPAMP circuit. The non-linear OPAMP circuit provides the desired non-linear amplification to the phase signal in order to mimic the gradual dimming associated with incandescent light bulbs as depicted by FIG. 3 and simulated in FIG. 11. The non-linear OPAMP circuit couples the amplified phase signal to the LED driver feedback path.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a model representation of the typical dimmer switch circuit;

FIG. 2 is a model representation of the typical LED luminosity output versus the LED current;

FIG. 3 is a shows the required modification to the dimmer control signal to negate the non-linear luminosity of LEDs shown in FIG. 2;

FIG. 4 is a schematic diagram of the non-linear load circuit that enables compatibility with a wide variety of dimmer switches;

FIG. 5 is a schematic diagram of the non-linear phase sense and amplifier circuit to generate a dimming signal for the LED driver feedback;

FIG. 6 is a schematic simulation model of the non-linear load circuit;

FIG. 7 is a simulation plot of the circuit modeled in FIG. 6, showing the load current to maintain dimmer switch conduction;

FIG. 8 is a simulation plot of the circuit modeled in FIG. 6, showing the load current to initiate conduction of the dimmer switch;

FIG. 9 is a schematic simulation model of the non-linear phase sense and amplifier circuit;

FIG. 10 is a simulation plot of the circuit modeled in FIG. 9;

FIG. 11 is the same simulation result as FIG. 10, but has been inverted and shifted to show the relationship between phase and dimmer control as depicted in FIG. 3;

FIG. 12 is a schematic block diagram of the invention coupled to four different embodiments;

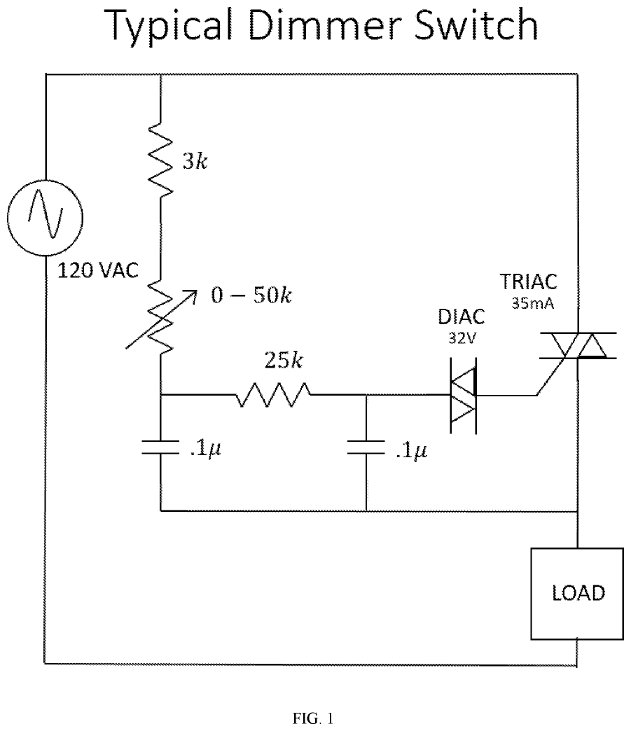

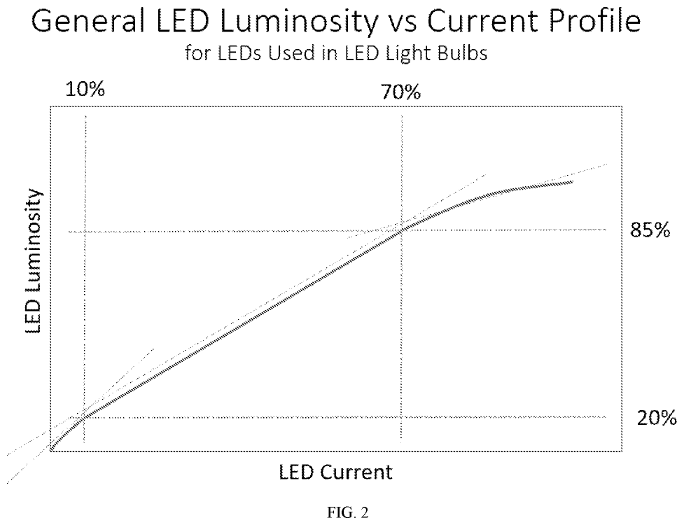

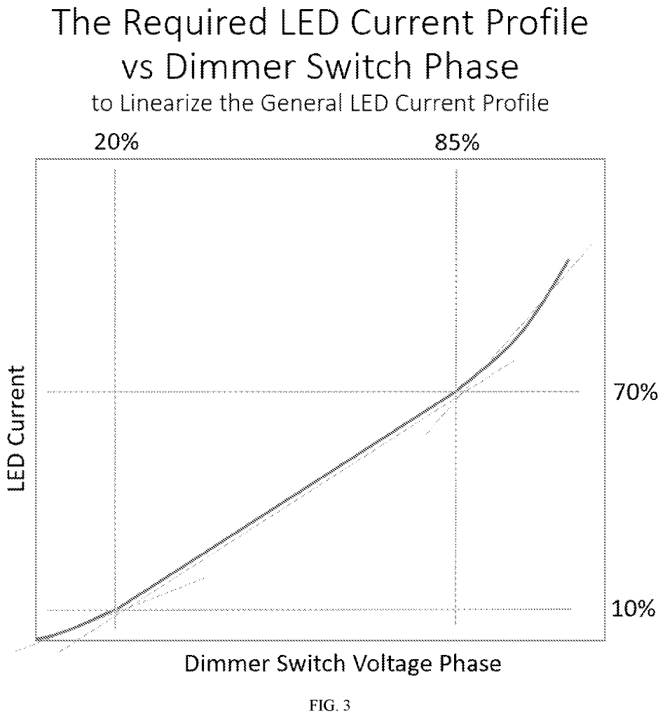

### DETAILED DESCRIPTION OF INVENTION

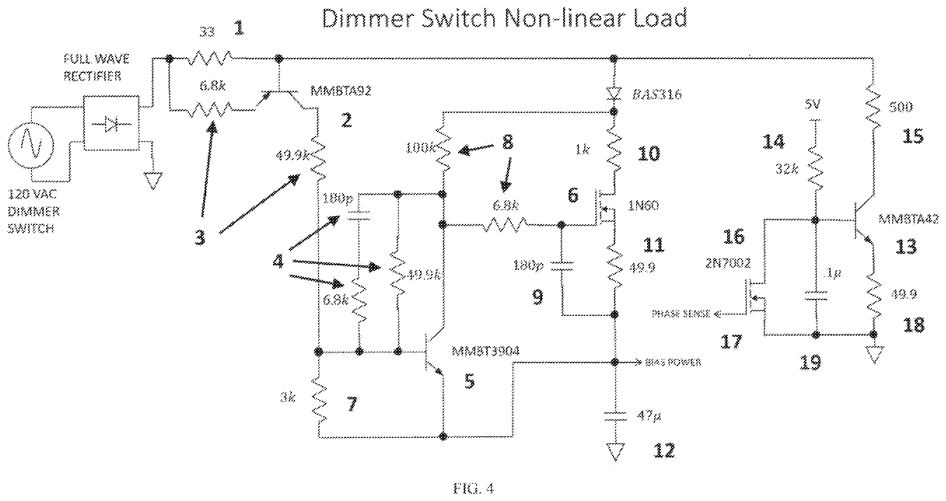

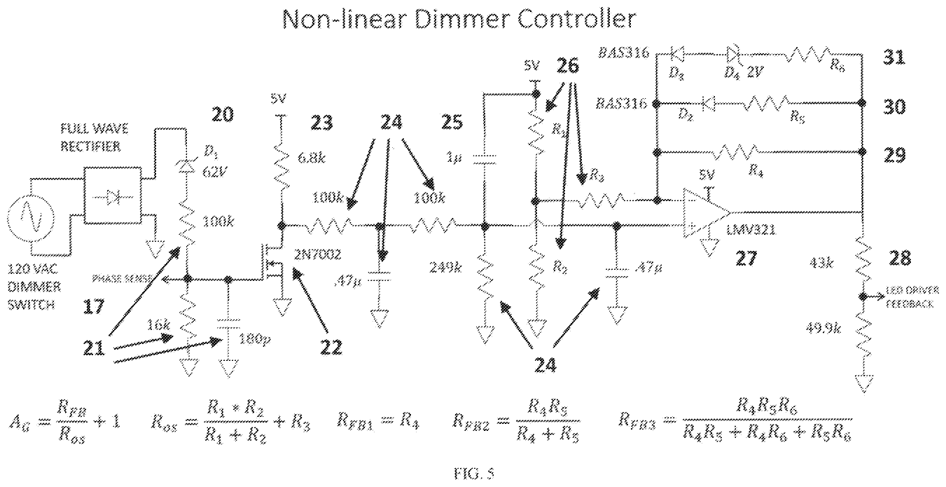

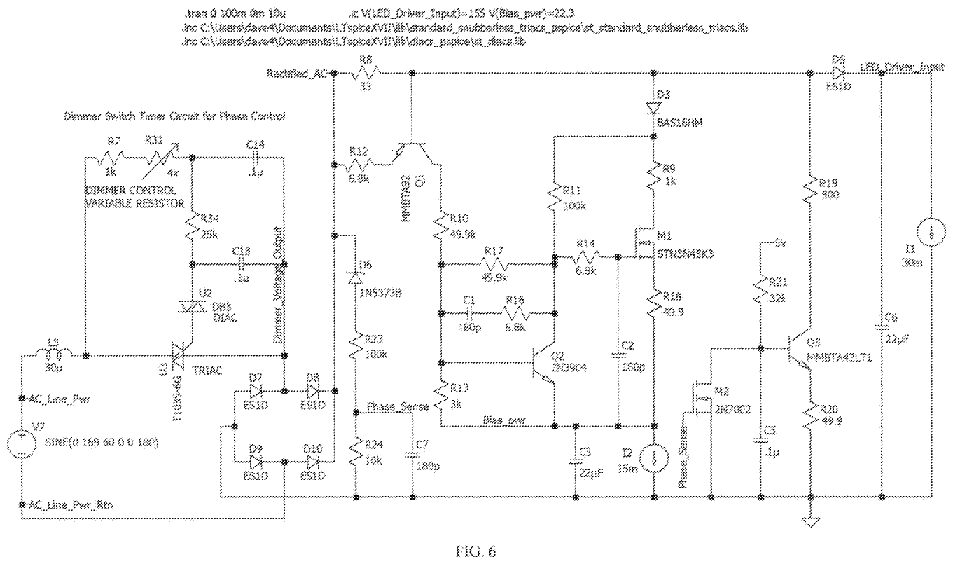

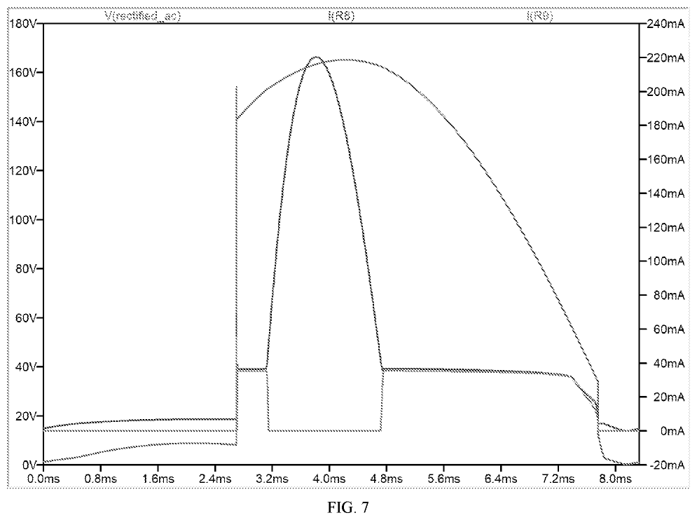

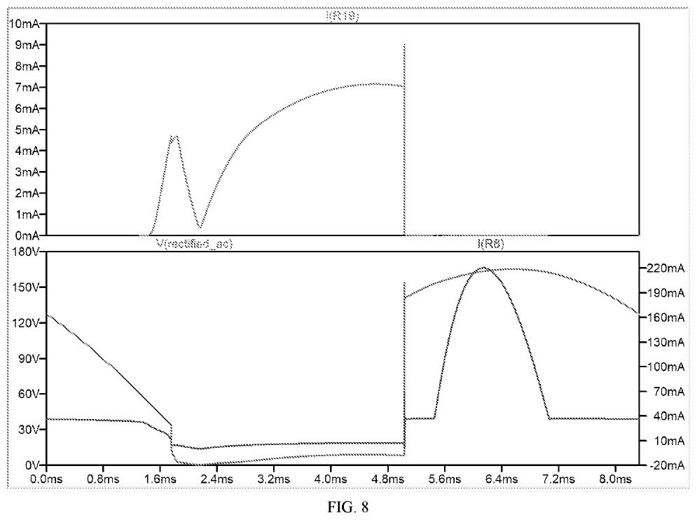

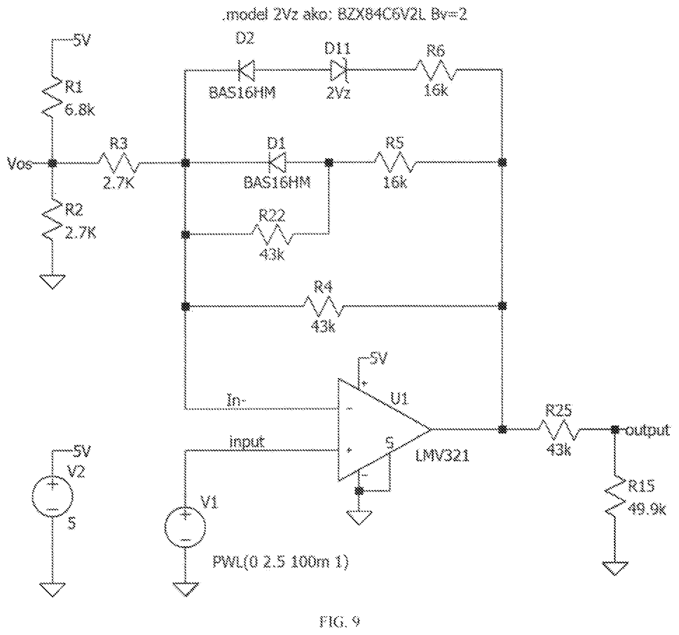

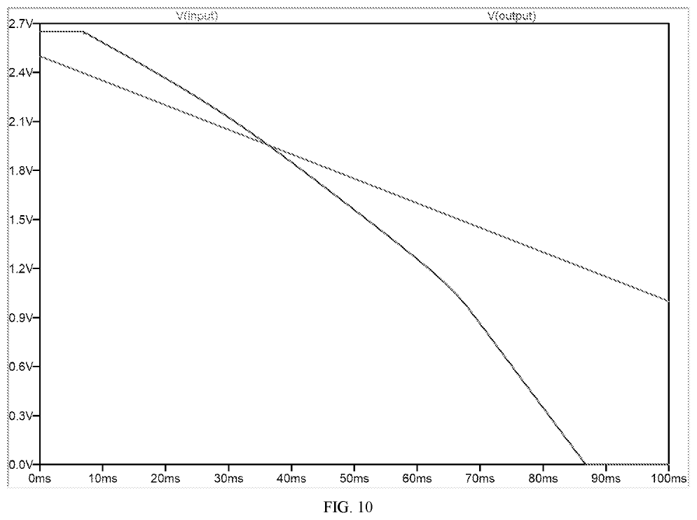

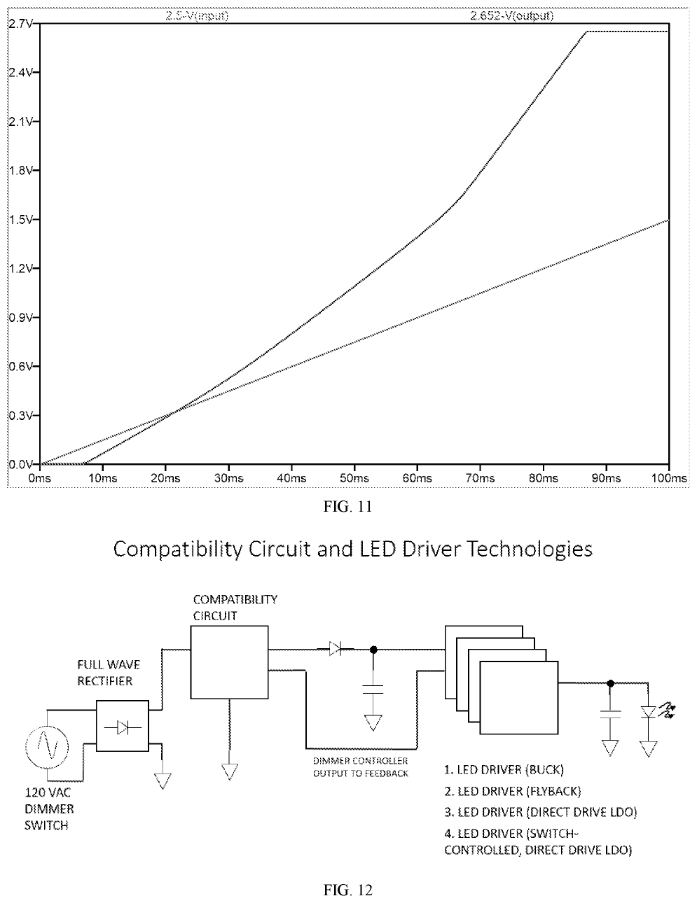

With reference to the drawings and in operation, the present invention overcomes at least some of the disadvantages of known dimmer switches from an AC mains supply (typically 120 VAC (US) to 264 VAC [EU/Asia]) by providing a non-linear load circuit and a dimmer controller circuit that ensures broad dimmer switch compatibility while controlling the brightness of the LEDs to mimic an incandescent light bulb. The non-linear load circuit shown in FIG. 4 is configured as two separate loads to provide the necessary resistance to the dimmer switch to initiate the conducting phase and to maintain the conducting phase. The first non-linear load circuit includes a PNP transistor current amplifier 2, a current sense resistor 1, a NPN transistor controller circuit 5, a N-channel MOSFET 6 that is coupled back to the current sense resistor 1. The PNP transistor current amplifier 2 also includes bias resistors 3. The NPN transistor controller circuit 5 includes a resistor and capacitor compensation network 4 to dampen the response to rapid changes in the input current. The base resistor 7 sets the gain of the NPN transistor controller circuit 5. The NPN transistor controller circuit 5 couples the PNP transistor current amplifier 2 to the N-channel MOSFET 6. The N-channel MOSFET 6 also includes bias resistors 8, load resistor 10, feedback resistor 11, and a capacitor 9. The sensed current by the PNP transistor amplifier circuit 2 is passed through the NPN transistor controller circuit's compensation network 4 and coupled to the N-channel MOSFET 6 to adjust the gate charge of the N-channel MOSFET 6 to adjust the resistance of the MOSFET to adjust the current load from the dimmer switch to maintain at least 30 mA of current. Another advantage of this circuit includes the option to return the current through the bias power supply capacitor 12 and thereby provide a charging current to supplement the power required to operate the LED driver. The second non-linear load circuit also couples to the current sense resistor 1, and it includes a NPN transistor 13, pull-up resistor 14, capacitor 19, load resistor 15, feedback resistor, and a N-channel MOSFET 16 off switch. The phase sense 17 of the dimmer circuit FIG. 5 couples to the NPN transistor 13 load through the N-channel MOSFET 16 to disable the load when the triac dimmer switch is in conduction. The load resistor 15 couples the NPN transistor 13 to the rectified AC electrical source. The feedback resistor 18 couples the NPN transistor 13 to ground. The pull-up resistor 14 and capacitor 19 couples the NPN transistor 13 to 5V with a time delay to bias it ‘on’. When the triac dimmer switch is off, the NPN transistor load 13 is enabled and presents an impedance less than 1 kohm to ensure the conducting phase timing will mimic that of an incandescent light bulb.

The dimmer controller circuit shown in FIG. 5 includes a dimming phase sense circuit, a filter circuit, and a non-linear OPAMP circuit. The dimming phase sense circuit includes a Zener diode 20, voltage sense resistors with a capacitor 21, and a N-channel MOSFET 22. The Zener diode 20 is coupled to a rectified AC input power source. The AC input rectified voltage is sensed through the Zener diode 20 to the sense resistors 21 to turn on a N-channel MOSFET 22. The N-channel MOSFET 22 couples the dimming phase sense circuit to the filter circuit. The filter circuit includes a pull-up resistor 23, two low pass filters 24, and a pull-up capacitor 25. The dimming phase sense circuit creates a pulse width modulation signal whose duty cycle is proportional to the conducting phase of the dimmer switch. The filter circuit pulls the PWM signal high with the pull-up resistor 23 and then passes the signal through two low pass filters 24 to create a DC proportional conducting phase signal. The DC signal is pulled high by the pull-up capacitor 25 at start-up to aid in soft-start dimming control. The second low pass filter 24 couples the filter circuit to the non-linear OPAMP circuit. The non-linear OPAMP circuit includes a bias resistor circuit 26, a feedback circuit, a general purpose OPAMP 27, and a resistor voltage divider output 28. The bias resistor circuit 26 provides a voltage offset to the non-linear OPAMP circuit for compatibility with the LED driver feedback path. The feedback circuit within the OPAMP circuit includes resistors, diodes, and a Zener diode. The feedback circuit 27 features three feedback paths: single resistor 29, single diode 30, Zener diode 31. The single resistor feedback path 29 is the only path when the input is low because the single diode path 30 and the Zener diode path 31 are not yet conducting. This sets up a much higher gain when the dimmer phase delay is shortest (near full brightness). The higher gain allows for rapid change in the LED current for a relative small change in the phase delay of the dimmer voltage conduction. As the dimmer switch's phase delay increases, the DC proportional conducting phase signal increases. The non-linear OPAMP feedback path containing the single diode 30 will activate and the overall gain will decrease. As the dimmer switch's phase delay continues to increase, the DC proportional conducting phase signal will also continue to increase. The non-linear OPAMP feedback path containing the Zener diode 31 will activate and the overall gain will decrease further. The lower gains allow for small change in the LED current for relatively small changes in the phase of the dimmer voltage conduction. The end result of the non-linear OPAMP is the DC proportional conducting phase signal is now compensated to negate the non-linear characteristics in LED current. The resistor voltage divider 28 output scales down the DC proportional conducting phase signal and couples it to the

LED driver voltage feedback. The non-linear OPAMP circuit provides the desired voltage adjustment to the DC proportional conducting phase signal in order to modify the LED driver current in order to linearize gradual dimming of a LED light bulb that will mimic the dimming dynamic associated with incandescent light bulbs.

The non-linear load circuit and dimmer controller circuit (henceforth referred to as ‘the compatibility circuit’) are central to obtaining a compatible dimming LED light bulb with smooth gradual dimming output. The compatibility circuit's pass-thru power and dimmer control output may couple with one of the following LED driver topologies:

[1.] Buck

[2.] Flyback

[3.] Direct Drive LDO

[4.] Switch-Controlled, Direct Drive LDO

The non-linear load circuit and dimmer controller circuit will be described below along with the LED driver topology utilized to deliver a fully compatible LED light bulb.

In the illustrated embodiment shown in FIG. 12, the compatibility circuit is configured to receive rectified AC electrical power. The compatibility circuit is coupled to a Buck LED driver.

In another embodiment shown in FIG. 12, the compatibility circuit is configured to receive rectified AC electrical power. The compatibility circuit is coupled to a Flyback LED driver.

In another embodiment shown in FIG. 12, the compatibility circuit is configured to receive rectified AC electrical power. The compatibility circuit is coupled to a Direct Drive LDO LED driver.

In another embodiment shown in FIG. 12, the compatibility circuit is configured to receive rectified AC electrical power. The compatibility circuit is coupled to a Switch-Controlled, Direct Drive LDO LED driver.

Various embodiments of the disclosure have been described. These and other examples are within the scope of the following claims.

What is claimed is:

1. An electrical circuit for providing compatibility between LED drivers and most dimmer switches in LED light bulbs, comprising: a rectifier circuit configured to receive an alternating current (AC) power input signal from an electrical power source and generate a rectified direct current (DC) power signal; a non-linear load circuit coupled to the rectifier circuit for receiving the DC power signal from the rectifier circuit and providing a DC load current to initiate the conducting phase and to maintain the conducting phase of a dimmer switch; a dimmer controller circuit coupled to the rectifier circuit for receiving the DC power signal from the rectifier circuit and providing an analog control signal to the LED driver feedback path which negates the non-linear brightness inherent in LEDs.

2. An electrical circuit in accordance with claim 1, further comprising a non-linear load circuit coupled to the rectifier circuit for receiving the DC power signal from the rectifier circuit and providing a constant DC load current sufficient to maintain operation of the dimmer switch while in the ‘on’ phase.

3. An electrical circuit in accordance with claim 2, further comprising a current sense PNP transistor circuit coupled to a NPN signal amplifier and stabilization feedback network to generate a control signal for a NMOS transistor variable load circuit.

4. An electrical circuit in accordance with claim 2, further comprising a NMOS transistor coupled to the NPN signal amplifier through bias resistors and stabilized by feedback resistor, a capacitor, and a load resistor to provide the necessary load current to maintain the conducting phase of a dimmer switch.

5. An electrical circuit in accordance with claim 4, the NMOS transistor variable load circuit couples the return current through a bias power capacitor, providing some power to a LED driver controller.

6. An electrical circuit in accordance with claim 1, further comprising a non-linear load circuit coupled to the rectifier circuit for receiving the DC power signal from the rectifier circuit and providing DC load current sufficient to maintain operation of the dimmer switch while in the ‘off’ phase.

7. An electrical circuit in accordance with claim 6, further comprising a pre-biased NPN transistor coupled to the DC power signal through a load resistor to ensure sufficient load current to trigger the dimmer switch conduction phase.

8. An electrical circuit in accordance with claim 6, further comprising a capacitor and NMOS transistor to delay turning on the NPN transistor and to disable the NPN transistor when the dimmer switch begins conducting.

9. An electrical circuit in accordance with claim 1, comprising a dimming phase sense circuit, further comprising a 62V Zener diode coupled to the DC power signal to sense the voltage ‘on’ phase of the dimmer switch, further comprising voltage divider resistors and NMOS transistor to couple the sensed phase signal to the dimming filter circuit.

10. An electrical circuit in accordance with claim 9, comprising a dimming filter circuit, further comprising a pull-up resistor and two low-pass RC filters to couple the phase sense signal to the non-linear OPAMP circuit while converting the phase sense signal to a steady DC signal.

11. An electrical circuit in accordance with claim 9, comprising a pull-up capacitor to five volts to pre-bias the DC phase sense signal to ensure the dimming signal is low at power-up.

12. An electrical circuit in accordance with claim 9, comprising a non-linear OPAMP circuit to couple the filtered DC phase sense signal to the LED driver feedback path while providing non-linear amplification to the signal.

13. An electrical circuit in accordance with claim 9 further comprising: a bias resistor network to provide an offset voltage to the non-linear OPAMP output to ensure voltage level compatibility with the LED driver feedback; a general purpose OPAMP having input bias current less than 15 nA, input offset voltage less than 3 mV, 1 MHz gain bandwidth product, and max voltage of at least five volts to amplify the phase sense DC signal; a feedback circuit, comprising a resistor, diode and resistor, Zener diode and resistor to provide non-linear amplification for a given phase sense DC signal; a voltage divider circuit, comprising resistors to scale the non-linear OPAMP output signal to ensure voltage range compatibility with the LED driver feedback.
